(19) United States
(12) Patent Application Publication
(10) Pub. No.: US 2012/0314086 A1
(43) Pub. Date: Dec. 13, 2012

(54) CAMERA TEST AND CALIBRATION BASED ON SPECTRAL MONITORING OF LIGHT

(75) Inventors: Paul M. Hubel, Cupertino, CA (US); Richard L. Baer, Cupertino, CA (US)

(73) Assignee: APPLE INC., Cupertino, CA (US)

(21) Appl. No.: 13/491,427

(22) Filed: Jun. 7, 2012

Related U.S. Application Data
(60) Provisional application No. 61/494,834, filed on Jun. 8, 2011.

(51) Int. Cl. H04N 17/06

(52) U.S. Cl. 348/175; 348/187; 348/E17.002

(57) ABSTRACT

Systems and methods for testing and calibrating camera modules based on a benchmark standard are provided. The systems can include a receptacle for receiving a camera module under test and a spectrometer. The test station can capture a test measurement using the camera module under test while contemporaneously capturing a true measurement using the spectrometer. Using the true measurement, the test station can predict how the benchmark standard would have performed in those conditions and compare that expected performance to the test measurement. Any differences can be stored in memory within the camera module under test for later retrieval to optimize image processing.

### CROSS-REFERENCE TO RELATED APPLICATION

This application claims the benefit of U.S. Provisional Patent Application No. 61/494,834, filed Jun. 8, 2011, which is hereby incorporated by reference herein in its entirety.

### FIELD OF DISCLOSURE

This can relate to systems and methods for testing and calibrating camera modules.

### BACKGROUND OF THE DISCLOSURE

Existing systems and methods for testing and calibrating camera modules typically involve a comparison between a measurement captured by a unit under test and a benchmark measurement previously captured by a benchmark unit (i.e., a unit that exhibits ideal characteristics for the type of unit under test). However, this benchmark measurement may require frequent updates as the testing conditions change. For example, the output of one or more light sources used in testing may vary over time, and this change may impact the measurement captured by the unit under test. As another example, a target may change color (e.g., from dirt or dust on the target), and this change may also impact the measurement captured by the unit under test. There are also difficulties with identifying benchmark units and maintaining an inventory of benchmark units for test and calibration purposes. Accordingly, improved systems and methods for testing and calibrating camera modules are desired.

### SUMMARY OF THE DISCLOSURE

Systems and methods for testing and calibrating camera modules are provided. In some embodiments, there is provided test and calibration processes based on a benchmark standard (e.g., a benchmark spectral sensitivity). Each camera module produced can be compared to the benchmark standard to determine its quality and calibrate the camera module based on any differences between its performance and that of the benchmark standard.

In some embodiments, there is provided a test station for testing and calibrating camera modules based on a benchmark standard. The test station can include a receptacle for receiving a camera module under test and a spectrometer. The test station can capture a test measurement using the camera module under test while contemporaneously capturing a true measurement using the spectrometer. Using the true measurement, the test station can predict how the benchmark standard would have performed in those conditions and compare that expected performance to the test measurement. Any differences can be stored in memory within the camera module under test for later retrieval to optimize image processing.

### BRIEF DESCRIPTION OF THE DRAWINGS

The above and other aspects of the invention, its nature, and various features will become more apparent upon consideration of the following detailed description, taken in conjunction with the accompanying drawings, in which like reference characters may refer to like parts throughout, and in which:

FIG. 1 is a schematic view of an illustrative camera module, in accordance with some embodiments of the invention;

FIG. 2 is a schematic view of an illustrative electronic device, in accordance with some embodiments of the invention;

FIG. 3 is a block diagram of an illustrative test station, in accordance with some embodiments of the invention;

FIG. 4 is a flow chart of an illustrative process for testing and calibrating camera modules, in accordance with some embodiments of the invention;

FIG. 5 is a flow chart of an illustrative process for testing camera modules, in accordance with some embodiments of the invention;

FIG. 6 is a flow chart of an illustrative process for testing and calibrating camera modules, in accordance with some embodiments of the invention;

FIG. 7 is a flow chart of an illustrative process for camera measurement synchronization, in accordance with some embodiments of the invention; and

FIG. 8 is a flow chart of an illustrative process for camera measurement synchronization, in accordance with some embodiments of the invention.

### DETAILED DESCRIPTION

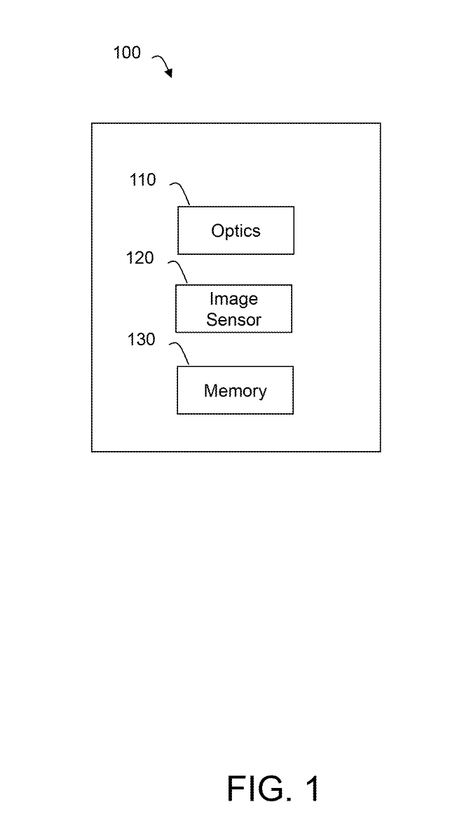

Systems and methods for testing and calibrating camera modules are provided and described with reference to FIGS. 1-7.

The following discussion describes various embodiments of testing and calibrating camera modules. The term “camera module” can include, but is not limited to, camera modules, imagers, camera subassemblies, and fully-assembled cameras, whether configured to capture still images, videos or both. For capturing images in low-light conditions, a camera module may include an integrated flash unit or an interface configured to couple with a separate flash unit. Alternatively, a camera module may be configured to capture images without any assistance from a flash unit.

FIG. 1 is a schematic view of an illustrative camera module 100 in accordance with some embodiments of the invention. Camera module 100 may be used to capture images. For example, camera module 100 may output signals based on the light detected by camera module 100.

Camera module 100 may include, for example, optics 110, image sensor 120 and memory 130. In some embodiments, one or more components of camera module 100 may be combined or omitted. Moreover, camera module 100 may include other components not shown in FIG. 1. For example, camera module 100 may include an integrated flash unit, motion-sensing circuitry, a compass, positioning circuitry, or several instances of the components shown in FIG. 1. For the sake of simplicity, only one of each of the components is shown in FIG. 1.

Optics 110 can include any suitable optics for collecting light. For example, optics 110 can include a lens for collecting and focusing light to be captured by image sensor 120. In some embodiments, optics 110 may simply include an aperture or lumen that allows light to reach image sensor 120.

Image sensor 120 can include any image sensor suitable for generating electrical signals based on light. For example, image sensor 120 can include a Charge-Coupled Device (CCD) image sensor or a Complementary Metal-Oxide-Semiconductor (CMOS) image sensor, any other suitable type of sensor, or any combination thereof. Image sensor 120 may be configured to capture still images, video or both. Image sensor 120 can include any suitable number of pixel sensors. In some embodiments, image sensor 120 can include filters for different colors of light (e.g., red filters, green filters and blue filters).

Memory 130 can include one or more storage mediums for storing data and/or software. For example, memory 130 can include non-volatile memory, flash memory, permanent memory such as read-only memory (“ROM”), semi-permanent memory such as random access memory (“RAM”), any other suitable type of storage component, or any combination thereof. In some embodiments, memory 130 may include one or more buffers for temporarily storing output signals from image sensor 120.

Camera module 100 may be designed for integration into, or may already be integrated with, a larger electronic device, such as a desktop computer, a laptop computer, a tablet or a mobile device. For example, a camera module may be configured for integration into an iMac™, MacBook™, iPad™, iPhone™ or iPod™ made available by Apple Inc. of Cupertino, Calif.

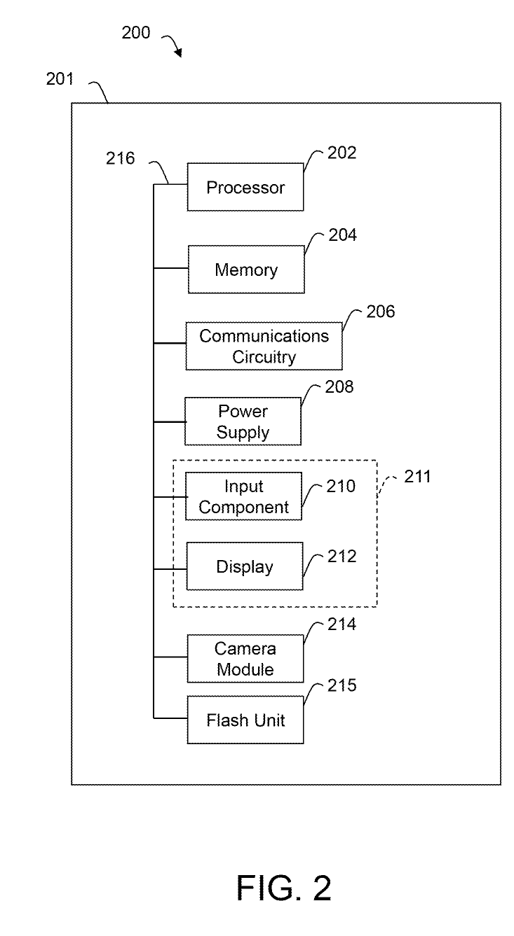

FIG. 2 is a schematic view of an illustrative electronic device 200 in accordance with some embodiments of the invention. Electronic device 200 may be any portable, mobile, or hand-held electronic device configured to capture images. Alternatively, electronic device 200 may not be portable, but may instead be generally stationary. Electronic device 200 can include, but is not limited to, a music player (e.g., an iPod™ made available by Apple Inc. of Cupertino, Calif.), video player, still image player, game player, other media player, music recorder, movie or video camera or recorder, still camera, other media recorder, radio, medical equipment, domestic appliance, transportation vehicle instrument, musical instrument, calculator, cellular telephone (e.g., an iPhone™ made available by Apple Inc.), other wireless communication device, personal digital assistant, remote control, pager, computer (e.g., a desktop, laptop, tablet, server, etc.), monitor, television, stereo equipment, set up box, set-top box, boom box, modem, router, printer, and combinations thereof. In some embodiments, electronic device 200 may perform a single function (e.g., a device dedicated to capturing images) and, in other embodiments, electronic device 200 may perform multiple functions (e.g., a device that captures images, plays music, and facilitates telephone calls).

Electronic device 200 may include a processor 202, memory 204, communications circuitry 206, power supply 208, input component 210, display 212, camera module 214 and flash unit 215. Electronic device 200 may also include a bus 216 that may provide one or more wired or wireless communication links or paths for transferring data and/or power to, from, or between various other components of device 200. In some embodiments, one or more components of electronic device 200 may be combined or omitted. For example, camera module 214 may be combined with flash unit 215 such that the flash unit is integrated into camera module 214. Moreover, electronic device 200 may include other components not shown in FIG. 2. For example, electronic device 200 may include motion-sensing circuitry, a compass, positioning circuitry, or several instances of the components shown in FIG. 2. For the sake of simplicity, only one of each of the components is shown in FIG. 2.

Camera module 214 may be substantially similar to camera module 100 shown in FIG. 1 and the previous description of the latter can be applied to the former. For example, in accordance with the disclosure, camera module 100 can be tested and calibrated and then integrated into electronic device 200 as camera module 214.

Flash unit 215 can include any suitable light source for illuminating a scene when camera module 214 captures an image. For example, flash unit 215 can include one or more light emitting diodes (LED). In some embodiments, camera module 214 can include precise timing circuitry to time the operation of flash unit 215 based on camera module 214.

Memory 204 may include one or more storage mediums for storing data and/or software. For example, memory 204 can include a hard-drive, non-volatile memory, flash memory, permanent memory such as read-only memory (“ROM”), semi-permanent memory such as random access memory (“RAM”), any other suitable type of storage component, or any combination thereof. Memory 204 may include cache memory, which may be one or more different types of memory used for temporarily storing data for electronic device applications. Memory 204 may store media data (e.g., music and image files), software (e.g., for implementing functions on device 200), firmware, preference information (e.g., media playback preferences), lifestyle information (e.g., food preferences), exercise information (e.g., information obtained by exercise monitoring equipment), transaction information (e.g., information such as credit card information), wireless connection information (e.g., information that may enable device 200 to establish a wireless connection), subscription information (e.g., information that keeps track of podcasts or television shows or other media a user subscribes to), contact information (e.g., telephone numbers and e-mail addresses), calendar information, any other suitable data, or any combination thereof.

Communications circuitry 206 may be provided to allow device 200 to communicate with one or more other electronic devices or servers using any suitable communications protocol. For example, communications circuitry 206 may support Wi-Fi (e.g., an 802.11 protocol), Ethernet, Bluetooth™, high frequency systems (e.g., 900 MHz, 2.4 GHz, and 5.6 GHz communication systems), infrared, transmission control protocol/internet protocol (“TCP/IP”) (e.g., any of the protocols used in each of the TCP/IP layers), hypertext transfer protocol (“HTTP”), BitTorrent™, file transfer protocol (“FTP”), real-time transport protocol (“RTP”), real-time streaming protocol (“RTSP”), secure shell protocol (“SSH”), any other communications protocol, or any combination thereof. Communications circuitry 206 may also include circuitry that can enable device 200 to be electrically coupled to another device (e.g., a host computer or an accessory device) and communicate with that other device, either wirelessly or via a wired connection.

Power supply 208 may provide power to one or more of the components of device 200. In some embodiments, power supply 208 can be coupled to a power grid (e.g., when device 200 is not a portable device, such as a desktop computer). In some embodiments, power supply 208 can include one or more batteries for providing power (e.g., when device 200 is a portable device, such as a cellular telephone). As another example, power supply 208 can be configured to generate power from a natural source (e.g., solar power using solar cells).

One or more input components 210 may be provided to permit a user to interact or interface with device 200. For example, input component 210 can take a variety of forms, including, but not limited to, a touch pad, dial, click wheel, scroll wheel, touch screen, one or more buttons (e.g., a keyboard), mouse, joy stick, track ball, microphone, proximity sensor, light detector, motion sensors, and combinations thereof. Each input component 210 can be configured to provide one or more dedicated control functions for making selections or issuing commands associated with operating device 200.

Electronic device 200 may also include one or more output components that may present information (e.g., graphical, audible, and/or tactile information) to a user of device 200. An output component of electronic device 200 may take various forms, including, but not limited to, audio speakers, headphones, audio line-outs, visual displays, antennas, infrared ports, rumblers, vibrators, or any combination thereof.

For example, electronic device 200 may include display 212 as an output component. Display 212 may include any suitable type of display or interface for presenting visual data to a user. In some embodiments, display 212 may include a display embedded in device 200 or coupled to device 200 (e.g., a removable display). Display 212 may include, for example, a liquid crystal display (“LCD”), a light emitting diode (“LED”) display, an organic light-emitting diode (“OLED”) display, a surface-conduction electron-emitter display (“SED”), a carbon nanotube display, a nanocrystal display, any other suitable type of display, or any combination thereof. Alternatively, display 212 can include a projecting system for providing a display of content on a surface remote from electronic device 200, such as, for example, a video projector, a head-up display, or a three-dimensional (e.g., holographic) display. As another example, display 212 may include a digital or mechanical viewfinder, such as a viewfinder of the type found in compact digital cameras, reflex cameras, or any other suitable still or video camera.

In some embodiments, display 212 may include display driver circuitry, circuitry for driving display drivers, or both. Display 212 can be operative to display content (e.g., media playback information, application screens for applications implemented on electronic device 200, information regarding ongoing communications operations, information regarding incoming communications requests, device operation screens, etc.) that may be under the direction of processor 202. Display 212 can be associated with any suitable characteristic dimensions defining the size and shape of the display. For example, the display can be rectangular or have any other polygonal shape, or alternatively can be defined by a curved or other non-polygonal shape (e.g., a circular display). Display 212 can have one or more primary orientations for which an interface can be displayed, or can instead or in addition be operative to display an interface along any orientation selected by a user.

It should be noted that one or more input components and one or more output components may sometimes be referred to collectively herein as an input/output (“I/O”) component or I/O interface (e.g., input component 210 and display 212 as I/O component or I/O interface 211). For example, input component 210 and display 212 may sometimes be a single I/O component 211, such as a touch screen, that may receive input information through a user's touch of a display screen and that may also provide visual information to a user via that same display screen.

Processor 202 of device 200 may include any processing circuitry operative to control the operations and performance of one or more components of electronic device 200. For example, processor 202 may be used to run operating system applications, firmware applications, graphics editing applications, media playback applications, media editing applications, or any other application. In some embodiments, processor 202 may receive input signals from camera module 214. For example, processor 202 may receive and process signals after camera module 214 captures an image. Processor 202 can access memory in camera module 214 (see, e.g., memory 130 shown in FIG. 1) and use any data stored in the camera module's memory (e.g., data related to the camera module's prior testing and/or calibration) to optimize how processor 202 processes the signals received from camera module 214. In some embodiments, processor 202 may receive input signals from input component 210 and/or drive output signals through display 212. Processor 202 may load a user interface program (e.g., a program stored in memory 204 or another device or server) to determine how instructions or data received via an input component 210 may manipulate the way in which information is stored and/or provided to the user via an output component (e.g., display 212). Electronic device 200 (e.g., processor 202, memory 204, or any other components available to device 200) may be configured to process graphical data at various resolutions, frequencies, intensities, and various other characteristics as may be appropriate for the capabilities and resources of device 200.

Electronic device 200 may also be provided with a housing 201 that may at least partially enclose one or more of the components of device 200 for protection from debris and other degrading forces external to device 200. In some embodiments, one or more of the components may be provided within its own housing (e.g., input component 210 may be an independent keyboard or mouse within its own housing that may wirelessly or through a wire communicate with processor 202, which may be provided within its own housing).

In accordance with the disclosure, the camera module may be tested and/or calibrated at one or more stages in the manufacturing process. For example, a camera module may be tested after manufacture, but before it is integrated with any other components or a larger electronic device (see, e.g., device 200), to ensure that it meets one or more minimum performance requirements and may also be calibrated to compensate for any manufacturing variance. As another example, a camera module may be tested before and/or after it is shipped to an assembly location to ensure that it meets one or more specifications. As yet another example, a camera module may be tested, and potentially calibrated again, after it has been fully incorporated into a larger electronic device (see, e.g., device 200). Each time the camera module is tested and/or calibrated, a test station in accordance with the disclosure can be used to perform the test and/or calibration.

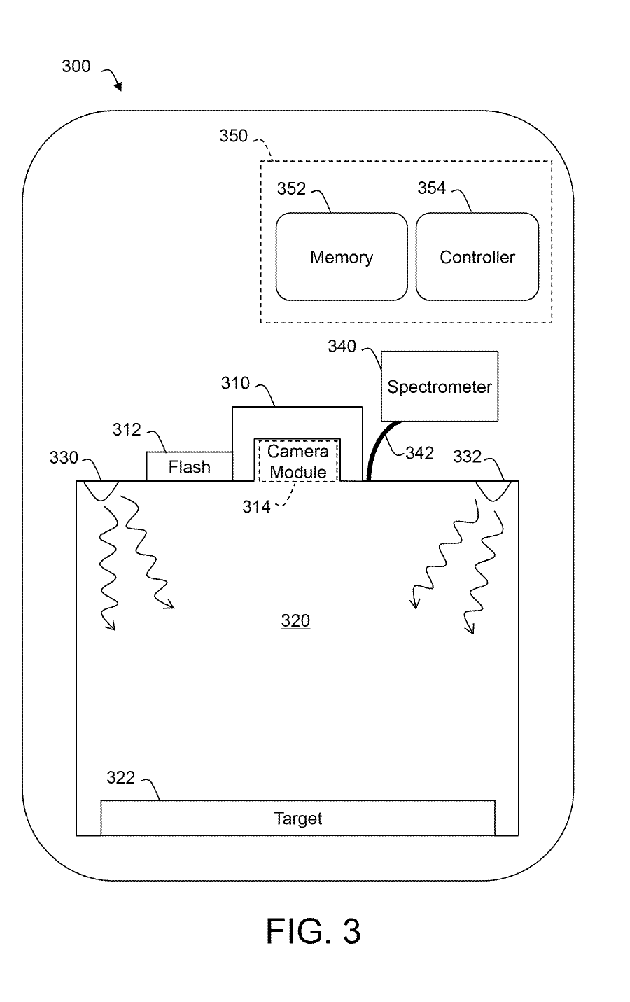

FIG. 3 is a block diagram of an illustrative test station 300 in accordance with some embodiments of the invention. Test station 300 may be used to test and/or calibrate camera modules (see, e.g., camera module 100 shown in FIG. 1 and camera module 214 shown in FIG. 2) in accordance with the disclosure.

Test station 300 can include receptacle 310 configured to receive the camera module under test (i.e., the camera module being tested and/or calibrated). For the purposes of illustration, camera module 314 is shown in FIG. 3 to represent a camera module under test, but it is understood that the camera module under test may be constantly replaced as new camera modules are tested and/or calibrated. Receptacle 310 can include a physical fixture for receiving the camera module under test. In some embodiments, receptacle 310 can also include one or more electrical connectors for coupling with the camera module under test. For example, receptacle 310 can include an electrical connector similar to a connector found in the electrical device with which the camera module will eventually be integrated (e.g., a connector that electronic device 200 can use to couple with the camera module).

While the previous description of receptacle 310 relates to receiving a camera module before it is integrated into a larger electronic device (see, e.g., device 200), it is understood that in some embodiments test station 300 and receptacle 310 can be configured for testing and/or calibrating camera modules after integration into a larger electronic device (see, e.g., camera module 214 in device 200). For example, receptacle 310 may include a physical fixture for receiving all or a portion of the electronic device and an electrical connector for electrically coupling with the camera module through an external connector on the electronic device.

In some embodiments, test station 300 can include flash unit 312 electrically coupled to receptacle 310 for providing light in coordination with the camera module under test. For example, flash unit 312 can be similar to, or even the same component as, a flash unit in the electrical device with which the camera module will eventually be integrated (e.g., flash unit 215 in device 200). Flash unit 312 can, in response to a signal from the camera module under test, provide light to illuminate a subject (e.g., target 322 to be discussed further below) when the camera module under test captures a measurement. It is understood that, in embodiments where the camera module under test includes an integrated flash unit, test station 300 may not include flash unit 312 or test station 300 may deactivate or decouple flash unit 312 in favor of a flash unit integrated into the camera module under test.

Test station 300 can include cavity 320 for testing the camera module under test. Cavity 320 can be located adjacent to receptacle 310 such that the camera module under test is aiming into cavity 320. In some embodiments, cavity 320 can be open on one or more sides for easy access to receptacle 310 and the camera module under test. In some embodiments, test station 300 may include a moveable portion (e.g., a door or hatch) so that cavity 320 can be fully enclosed during testing. In some embodiments, test station 300 may include one or more seals to prevent external light from entering cavity 320 during testing.

Test station 300 can include target 322 for testing the camera module under test. Target 322 can be positioned in cavity 320 so that the camera module under test can capture an image of the target. Target 322 can be any color suitable for testing the camera module under test. For example, target 322 can be a neutral shade of gray such that measurements captured by the camera module under test indicate the color performance of the camera module under test. Target 322 can include any finish suitable for testing the camera module under test. For example, target 322 can include a reflective finish to maximize the amount of light reflected towards the camera module under test.

Test station 300 can include light source 330 configured to illuminate target 322. Light source 330 can be pointed towards target 322 to illuminate the target. Light source 330 can include any type of light source suitable for testing the camera module under test. For example, light source 330 can include a halogen light source or an LED light source. Test station 300 may be capable of selectively enabling and disabling light source 330. For example, test station 300 can enable light source 330 for capturing a measurement with the camera module under test but disable light source 330 when the test station is idle.

In some embodiments, test station 300 can include a second light source 332 configured to illuminate target 322. Light source 332 can be pointed towards target 322 to illuminate the target. Light source 332 can be spaced apart from light source 330 or it can be adjacent to light source 330. Light source 332 can include any type of light source suitable for testing the camera module under test. In some embodiments, light source 332 can include a different type of light source compared to light source 330. For example, light source 332 can include a fluorescent light source. In embodiments where light source 330 includes a halogen light source and light source 332 includes a fluorescent light source, each of the light sources can provide light with a different color temperature for testing the camera module under test. Test station 300 may be capable of selectively enabling and disabling light source 332. For example, test station 300 can enable light source 332 for capturing a measurement with the camera module under test but disable light source 332 when the test station is idle.

In some embodiments, test station 300 may be capable of selectively enabling and disabling light source 330 and light source 332. For example, test station 300 may enable light source 330 and disable light source 332 for one measurement and then disable light source 330 and enable light source 332 for a second measurement (or vice-versa). In some embodiments, test station 300 may, in addition to or in alternative to the individual measurements just described, capture a measurement with both light source 330 and light source 332 enabled.

In some embodiments, test station 300 may include a transmissive target with one or more light sources for backlighting the transmissive target. For example, target 322 can be a transmissive target that allows some light to pass through it, and light source 330 and/or light source 332 can be provided behind target 322 such that light from a light source passes through target 322 before it is received by the camera module under test. In such embodiments, light source 330 and/or light source 332 can be an LED light source. In accordance with the disclosure, the testing and calibration methods described herein may be performed using a reflective target, a transmissive target or a combination of reflective and transmissive targets.

In some embodiments, a test station may not include any light sources and may instead use a flash unit to illuminate a target. For example, test station 300 may not include light source 330 or light source 332 and may instead rely on flash unit 312 to illuminate target 322 for testing and calibration purposes.

Test station 300 can include spectrometer 340 (i.e., a spectrophotometer, a spectrograph or a spectroscope) for measuring the spectral composition of light in test station 300. Spectrometer 340 can, for example, be a compact and inexpensive spectrometer such as those made available by Ocean Optics, Inc. of Dunedin, Fla.; Avantes of Eerbeek, Netherlands; and Hamamatsu Photonics K.K. of Hamamatsu, Japan. Spectrometer 340 can capture highly accurate measurements of spectral composition. For example, spectrometer 340 may capture measurements with sufficient accuracy to comply with the relevant standards set by the National Institute of Standards and Technology (NIST).

In some embodiments, spectrometer 340 can continuously capture measurements. In some embodiments, spectrometer 340 can capture measurements on regular intervals. In some embodiments, spectrometer 340 can capture a measurement based on a signal from test station 300. For example, test station 300 may operate spectrometer 340 and the camera module under test so that spectrometer 340 can only capture a measurement at the same time that the camera module under test captures a measurement (or vice-versa).

Test station 300 can include optical input path 342 for routing light to spectrometer 340. For example, optical input path 342 can be a fiber optic bundle configured to collect light for measurement by spectrometer 340. Optical input path 342 can extend from cavity 320 to spectrometer 340. One end of optical input path 342 can be pointed at target 322 such that optical input path 342 can collect light coming from target 322. In some embodiments, one end of optical input path 342 may be located near receptacle 310 so that optical input path 342 can receive light similar to that received by the camera module under test. In some embodiments, optical input path 342 may be incorporated into spectrometer 340 or attached to spectrometer 340.

Test station 300 can include control circuitry 350 for controlling one or more aspects of the test station's operation. Control circuitry 350 can be electrically coupled with one or more components in test station 300. Control circuitry 350 can be electrically coupled with receptacle 310 and therefore electrically couple with the camera module under test when it is inserted into receptacle 310 (see, e.g., camera module 314). When a camera module under test is inserted into receptacle 310, control circuitry 350 can trigger the camera module under test to capture a measurement and receive the captured measurement from the camera module under test. Control circuitry 350 can also be electrically coupled with spectrometer 340. Control circuitry 350 can receive measurements from spectrometer 340. In some embodiments, control circuitry 350 can also trigger spectrometer 340 to capture a measurement. In some embodiments, control circuitry 350 can be electrically coupled with light source 330 and second light source 332 (if present). Control circuitry 350 can include any suitable circuit or component for controlling test station 300. Control circuitry 350 may, for example, include memory 352 and controller 354.

Memory 352 can include one or more storage mediums for storing data and/or software. For example, memory 130 can include non-volatile memory, flash memory, permanent memory such as read-only memory (“ROM”), semi-permanent memory such as random access memory (“RAM”), any other suitable type of storage component, or any combination thereof. In some embodiments, memory 352 may store software used to operate test station 300 (e.g., software used to perform one or more of the processes described in this disclosure). In some embodiments, memory 352 may store measurements captured by the camera module under test as well as measurements captured by spectrometer 340. In some embodiments, memory 352 may store data related to one or more benchmark standards for the type of camera module under test, such as one or more benchmark spectral sensitivities. In some embodiments, memory 352 may store calibration data related to the camera module under test.

Controller 354 can include any processing circuitry or processor operative to control the operation of test station 300. In some embodiments, controller 354 can include a microcontroller or a central processing unit. Controller 354 can operate according to software stored on memory 352. In some embodiments, controller 354 can include integrated electronic storage to supplement or replace memory 352.

In accordance with the disclosure, camera modules can be tested and calibrated based on a benchmark standard (e.g., a benchmark spectral sensitivity). This benchmark standard can be associated with the manufacturing process used to produce the camera module under test because any particular manufacturing process can produce camera modules having generally similar properties, such as spectral sensitivity. Accordingly, a set of camera modules manufactured using the same process can be tested to determine a benchmark standard for all camera modules manufactured with that process.

Any suitable technique can be used to establish the benchmark standard. In some embodiments, the measurements captured by camera modules from an initial production run (i.e., a pilot run) can be collected and compared so that a camera module from the center of this distribution can be selected as the benchmark camera module. If a benchmark camera module is selected, it can be measured to determine any number of benchmark standards. In some embodiments, one or more spectral sensitivities of a benchmark camera module can be measured to determine the benchmark spectral sensitivity for different color channels (e.g., red, green, or blue). In some embodiments, rather than basing the benchmark standard on a single camera module, the benchmark standard may be derived from the measurements captured by multiple camera modules in the initial production run (e.g., the average of measurements from multiple camera modules).

In accordance with the disclosure, this benchmark standard may then be used to correct the output of all camera modules produced using the same manufacturing process. For example, the camera modules may be designed for integration into electronic devices that can process images captured by a camera module, and this processing can be optimized using the benchmark standard (e.g., benchmark spectral sensitivity) to generally correct the output of all camera modules. Moreover, if the differences between a particular camera module's performance and the benchmark standard are determined during camera calibration, these differences can be stored in that camera module and used to further optimize the processing of images captured by that particular camera module.

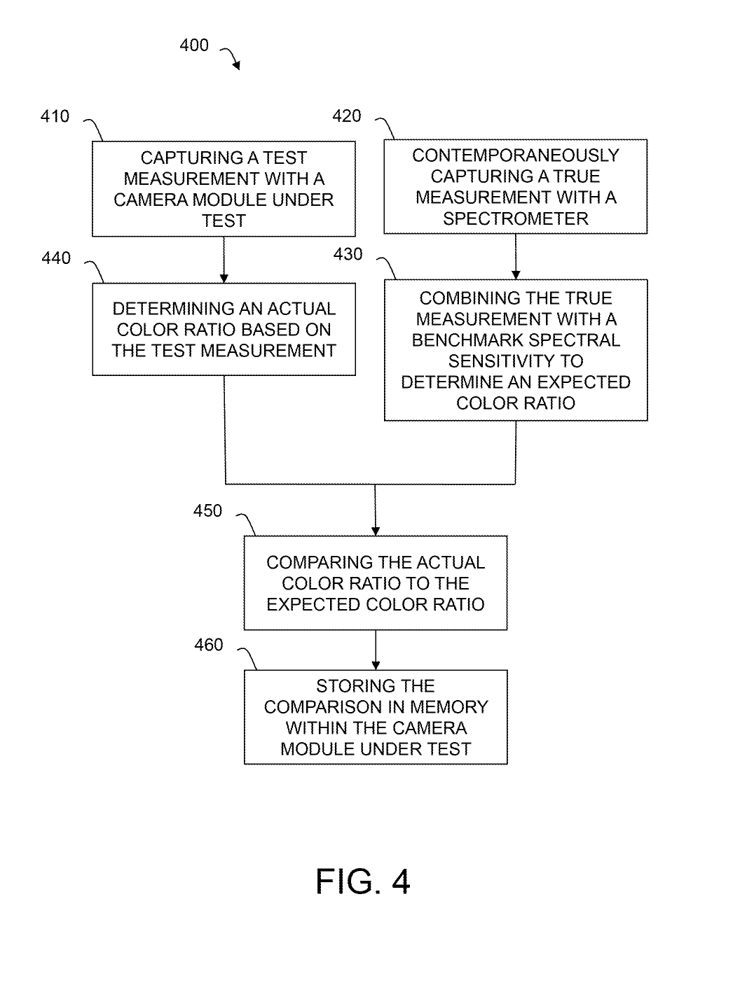

FIG. 4 is a flow chart of an illustrative process 400 for testing and calibrating camera modules in accordance with some embodiments of the invention. Process 400 can be used to test and calibrate any suitable type of camera module (see, e.g., camera module 100 shown in FIG.1 and camera module 214 shown in FIG. 2). Process 400 can be performed by test station 300 shown in FIG. 3. Process 400 can begin with blocks 410 and 420 occurring generally in parallel.

At block 410, a test measurement can be captured with a camera module under test. For example, receptacle 310 shown in FIG. 3 can receive a camera module under test and that camera module under test can be used to capture a test measurement. The test measurement can include an image or a more general measurement based on the light received by the camera module. In some embodiments, control circuitry 350 shown in FIG. 3 can trigger the camera module under test to capture the test measurement.

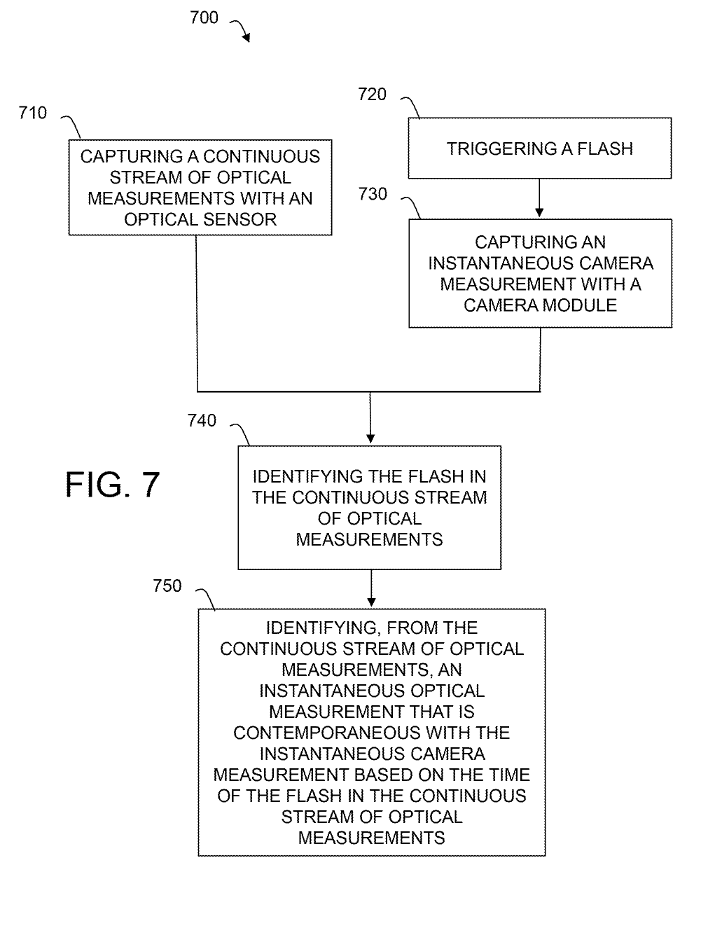

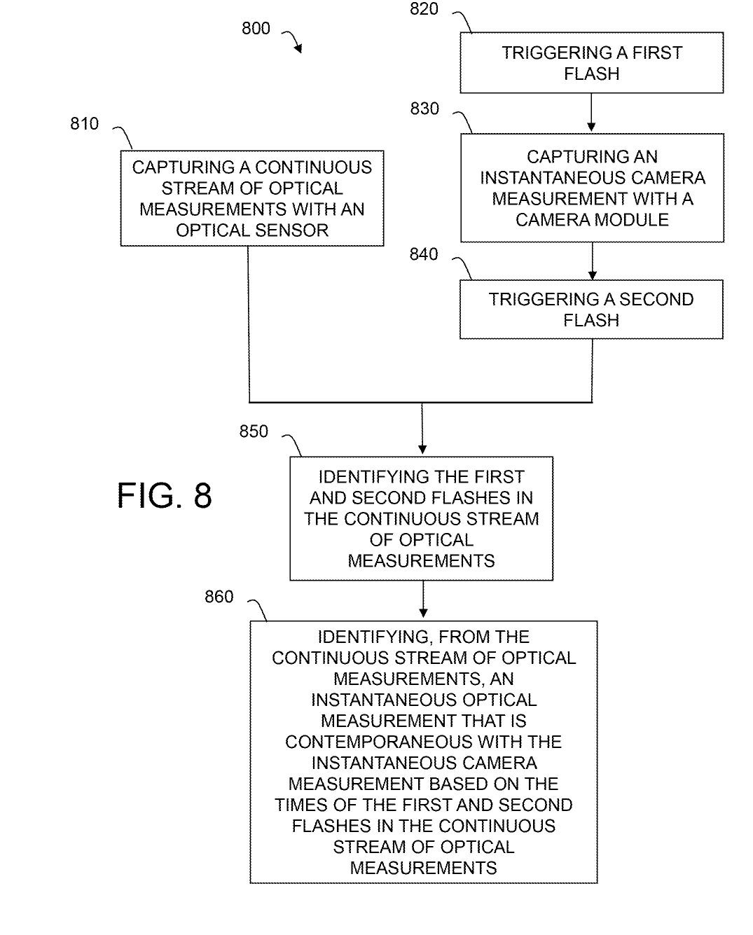

At block 420, a true measurement can be captured with a spectrometer. For example, spectrometer 340 shown in FIG. 3 can capture a true measurement at block 420. The true measurement can include the spectral distribution of the light received by the spectrometer. Block 410 and block 420 can occur contemporaneously so that the test measurement and the true measurement are both subject to the same lighting conditions. As previously explained, a spectrometer can continuously capture measurements or it can be triggered to capture a measurement. In some embodiments, control circuitry 350 shown in FIG. 3 can trigger spectrometer 340 to capture the true measurement. In other embodiments, spectrometer 340 shown in FIG. 3 may be continuously or periodically capturing measurements so that control circuitry 350 may not specially trigger the spectrometer to capture the true measurement. In some embodiments, the true measurement that is contemporaneous with the test measurement from the camera module under test can be identified using a process for camera measurement synchronization (see, e.g., process 700 shown in FIG. 7 and process 800 shown in FIG. 8, both of which are discussed further below).

At block 430, the true measurement can be combined with a benchmark spectral sensitivity to determine an expected color ratio. As previously discussed, the benchmark spectral sensitivity can be based on the performance of a benchmark camera module. Accordingly, the true measurement from the spectrometer can be combined with the benchmark spectral sensitivity to determine the expected performance of a benchmark camera module under the same conditions (e.g., the expected color ratio). The expected color ratio can be any suitable ratio of two or more color channels. For example, the expected color ratio can be the expected ratio of red-to-green or the expected ratio of blue-to-green.

For example, to determine the expected ratio of red-to-green, the true measurement from the spectrometer can be combined with the benchmark spectral sensitivity according to the following equation:

$$\frac{R}{G} = \frac{\int {M}_{R} ( λ ) L ( λ ) d λ}{\int {M}_{G} ( λ ) L ( λ ) d λ}$$

In this equation, the benchmark spectral sensitivity includes a red channel and a green channel, noted respectively as M_{R}(λ) and M_{G}(λ), and the true measurement from the spectrometer is represented as L(λ). Any suitable range of values can be used to perform the integration, but it may be more efficient to limit the integration to a range of values for which the integrand has a relatively significant value. For example, the integration can be performed for the range extending between 600 nm and 800 nm. Applying this same approach to determine the ratio of blue-to-green, the following equation can be used:

$$\frac{B}{G} = \frac{\int {M}_{B} ( λ ) L ( λ ) d λ}{\int {M}_{G} ( λ ) L ( λ ) d λ}$$

In this equation, the benchmark spectral sensitivity includes an additional blue channel, noted as M_{B}(λ).

Any suitable processing circuitry can be used to perform the combination at block 430. For example, control circuitry 350 shown in FIG. 3 can combine the true measurement with a benchmark spectral sensitivity to determine an expected color ratio.

At block 440, an actual color ratio can be determined based on the test measurement. Any suitable process can be used to determine the actual color ratio. For example, the amount of light in one color channel of the test measurement can be compared to the amount of light in another color channel of the test measurement to determine the actual color ratio. Like the expect color ratio discussed with respect to block 430, the actual color ratio can be any suitable ratio of two or more color channels. For example, the actual color ratio can be the ratio of red-to-green or the ratio of blue-to-green.

Any suitable processing circuitry can be used to determine the actual color ratio at block 440. For example, control circuitry 350 shown in FIG. 3 can determine an actual color ratio based on the test measurement.

At block 450, the actual color ratio determined at block 440 can be compared to the expected color ratio determined at block 430. For example, the actual color ratio can be normalized with respect to the expected color ratio (e.g., generating a decimal value). Any difference between the actual color ratio and the expected color ratio may be attributable to the differences between the camera module under test and the benchmark camera module. Accordingly, this comparison can be used during regular operation of the camera module under test to optimize the processing of images captured by the camera module under test.

Any suitable processing circuitry can be used to compare the actual color ratio and the expected color ratio at block 450. For example, control circuitry 350 shown in FIG. 3 can compare the actual color ratio to the expected color ratio.

At block 460, the comparison between the actual color ratio and the expected color ratio can be stored in memory within the camera module under test. The comparison can be stored in any suitable format (e.g., a decimal value reflecting the normalization of the actual color ratio to the expected color ratio). The comparison may also be referred to as a normalized color ratio. The comparison can be written as data stored in the memory of the camera module under test (see, e.g., memory 130 shown in FIG. 1). If the camera module is eventually integrated into an electronic device (see, e.g., electronic device 200 shown in FIG. 2), the electronic device can access the comparison stored in the camera module's memory and use it to optimize image processing for the camera module.

Any suitable circuitry can be used for storing the comparison at block 460. For example, control circuitry 350 shown in FIG. 3 can store the comparison in the memory of the camera module under test (e.g., using the receptacle 310 to electrically couple with the camera module under test).

While the previous description of process 400 discussed determining a single expected color ratio, determining a single actual color ratio, and comparing the two, it is understood that any number of color ratios can be provided in accordance with the disclosure. For example, process 400 can be modified such that multiple color ratios (e.g., both the red-to-green ratio and the blue-to-green ratio) are determined based on a pair of test and true measurements and then stored in memory within the camera module under test. As another example, process 400 can be modified such that a first color ratio comparison (e.g., the red-to-green ratio comparison) is based on one pair of test and true measurements using a first light source (e.g., a halogen light source) and a second color ratio comparison (e.g., the blue-to-green ratio comparison) is based on a second pair of test and true measurements using a second light source of a different type (e.g., a fluorescent light source). In such embodiments, each of the comparisons can be stored in the memory of the camera module under test.

In accordance with the disclosure, a camera module that has previously been calibrated can be tested to determine if the calibration is accurate. For example, a camera module that has previously undergone process 400 can be tested at some later point in time, such as after it has been received at another location and/or before it is integrated into a larger electronic device, to determine if the calibration data stored in its memory is accurate.

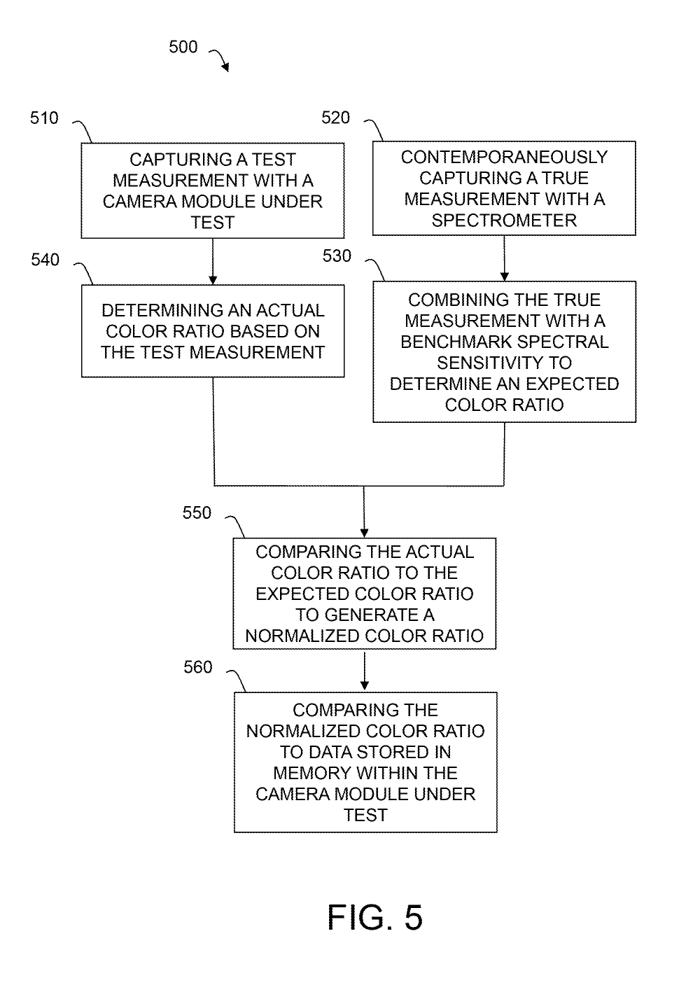

FIG. 5 is a flow chart of an illustrative process 500 for testing camera modules in accordance with some embodiments of the invention. Process 500 can be used to test any suitable type of camera module (see, e.g., camera module 100 shown in FIG. 1 and camera module 214 shown in FIG. 2). Process 500 can be performed by test station 300 shown in FIG. 3. Process 500 can begin with blocks 510 and 520 occurring generally in parallel. Blocks 510-540 of process 500 are substantially similar to blocks 410-440 of process 400, and the previous description of the latter can be applied to the former. Moreover, the same benchmark spectral sensitivity used to initially calibrate a camera module in accordance with process 400 can be used to later test a camera module according to process 500. It is understood that any shift in the benchmark spectral sensitivity may impact the test performed using process 500.

At block 550, the actual color ratio determined at block 540 can be compared to the expected color ratio determined at block 530 to generate a normalized color ratio. This normalized color ratio represents the comparison between the actual color ratio and the expected color ratio. Like the comparison performed in block 450 of process 400, the difference between the actual color ratio and the expected color ratio may be attributable to the differences between the camera module under test and the benchmark camera module.

Any suitable processing circuitry can be used to compare the actual color ratio and the expected color ratio to generate a normalized color ratio at block 550. For example, control circuitry 350 shown in FIG. 3 can compare the actual color ratio to the expected color ratio and generate a normalized color ratio.

At block 560, the normalized color ratio can be compared to data stored in memory within the camera module under test. For example, data can be read from the memory of the camera module under test (see, e.g., memory 130 shown in FIG. 1). This comparison can verify if the data stored in the camera module under test from a previous calibration (e.g., a previous application of process 400) is still accurate.

Any suitable circuitry can be used to compare the normalized color ratio to the data stored in memory at block 560. For example, control circuitry 350 shown in FIG. 3 can access the data stored in memory within the camera module and compare it two the normalized color ratio.

Like process 400, process 500 can be modified such that multiple color ratios (e.g., both the red-to-green ratio and the blue-to-green ratio) are determined based on a pair of test and true measurements and then compared to the normalized color ratios stored in memory within the camera module under test. As another example, process 500 can be modified such that a first color ratio comparison (e.g., the red-to-green ratio comparison) is based on one pair of test and true measurements using a first light source (e.g., a halogen light source) and a second color ratio comparison (e.g., the blue-to-green ratio comparison) is based on a second pair of test and true measurements using a second light source of a different type (e.g., a fluorescent light source).

In some embodiments, process 500 can correct data stored in memory within the camera module under test (e.g., memory 130 shown in FIG. 1) if it is sufficiently different from the normalized color ratio generated at block 550. For example, if the difference between the normalized color ratio generated at block 550 and data stored in memory of the camera module under test is greater than a predetermined threshold, process 500 can include an additional step in which the data stored in memory is updated. In some embodiments, the data stored in memory may be replaced with the normalized color ratio generated at block 550. In some embodiments, the data stored in memory may be averaged with the normalized color ratio generated at block 550.

Any suitable circuitry can be used to correct data stored in memory within the camera module under test. For example, control circuitry 350 shown in FIG. 3 can correct data stored in the memory of the camera module under test (e.g., using the receptacle 310 to electrically couple with the camera module under test).

In accordance with the disclosure, camera modules can be tested and calibrated based on the most similar benchmark standard selected from a collection of benchmark standards. In such embodiments, the same general principles governing process 400 apply, but instead of using a single benchmark standard for all camera modules that are produced by a particular manufacturing process, a pool of benchmark standards are used to select a benchmark standard that is the most similar to the camera module under test. Selecting the most similar benchmark standard from a pool of benchmark standards results in less difference between the camera module under test and the selected benchmark standard, which increases the accuracy of any image correction performed on the camera module's output.

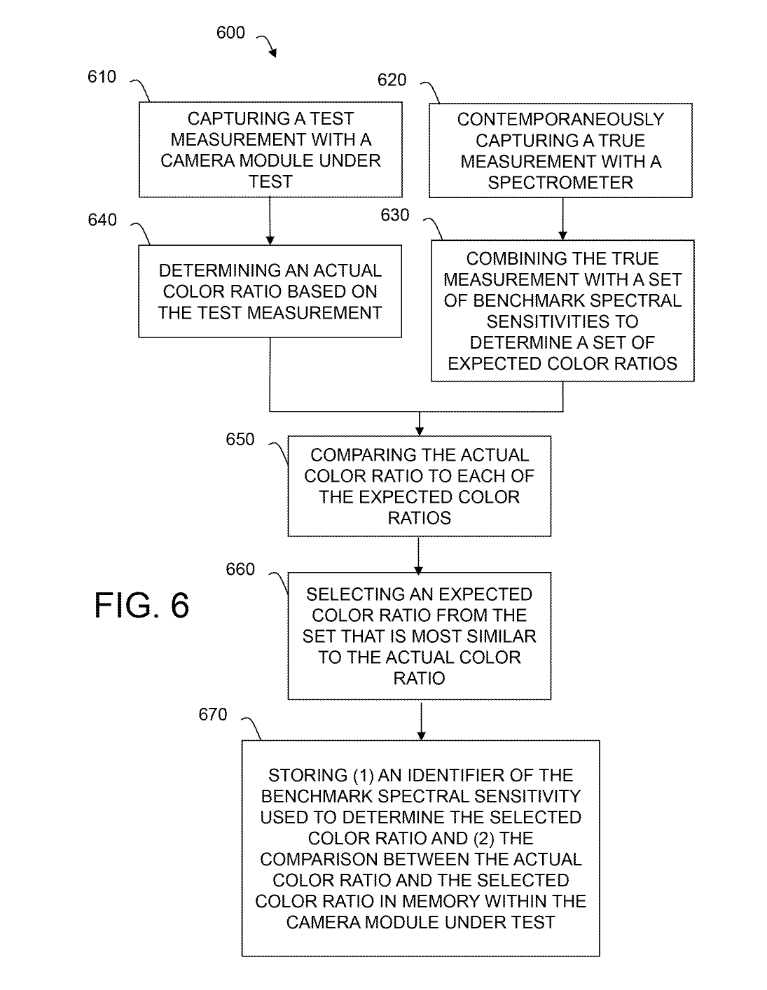

FIG. 6 is a flow chart of an illustrative process 600 for testing and calibrating camera modules in accordance with some embodiments of the invention. Process 600 can be used to test and calibrate any suitable type of camera module (see, e.g., camera module 100 shown in FIG. 1 and camera module 214 shown in FIG. 2). Process 600 can be performed by test station 300 shown in FIG. 3. Process 600 can begin with blocks 610 and 620 occurring generally in parallel. Blocks 610 and 620 of process 600 are substantially similar to blocks 410 and 420 of process 400, and the previous description of the latter can be applied to the former.

At block 630, the true measurement can be combined with a set of benchmark spectral sensitivities to determine a set of expected color ratios. For example, the true measurement can be combined with each benchmark spectral sensitivity to generate expected color ratios such that each ratio corresponds to a particular benchmark spectral sensitivity. The technique for combining the true measurement with each benchmark spectral sensitivity at block 630 is substantially similar to the technique used in block 430 of process 400 to combine a true measurement with a single benchmark spectral sensitivity, and the previous description of the latter applies to the former.

Any suitable processing circuitry can be used to perform the combinations at block 630. For example, control circuitry 350 shown in FIG. 3 can combine the true measurement with a set of benchmark spectral sensitivities to determine a set of expected color ratios. The set of expected color ratios determined at block 630 can be stored in any suitable electronic storage. For example, the set of expected color ratios determined at block 630 can be stored in memory 352 shown in FIG. 3.

At block 640, an actual color ratio can be determined based on the test measurement. Blocks 640 is substantially similar to block 440 of process 400, and the previous description of the latter can be applied to the former.

At block 650, the actual color ratio can be compared to each of the expected color ratios. For example, the actual color ratio can be compared to two or more expected color ratios from the set to determine the most similar color ratio.

Any suitable processing circuitry can be used to perform the comparisons at block 650. For example, control circuitry 350 shown in FIG. 3 can compare the actual color ratio to the expected color ratios.

At block 660, an expected color ratio from the set that is most similar to the actual color ratio can be selected. For example, based on the comparing at block 650, an expected color ratio can be selected that is most similar to the actual color ratio. In some embodiments, the expected color ratio selected at block 660 may correspond to the benchmark spectral sensitivity that is the most similar to the performance of the camera module under test. It can be advantageous to use such a benchmark standard for calibration because it is the benchmark standard most similar to the camera module under test.

Any suitable processing circuitry can be used to select the expected color ratio that is most similar to the actual color ratio at block 660. For example, control circuitry 350 shown in FIG. 3 can select the most similar expected color ratio.

At block 670, an identifier of the benchmark spectral sensitivity used to determine the selected color ratio and the comparison between the actual color ratio and the selected color ratio can be stored in memory within the camera module under test. As previously discussed (see, e.g., discussion with respect to block 460 of process 400), the comparison between the actual color ratio and the selected color ratio can be used later to perform image processing. However, in embodiments such as process 600 where the benchmark spectral sensitivity was chosen from a pool of benchmark spectral sensitivities, it can be beneficial to also store an identifier of the benchmark spectral sensitivity for use in later image processing.

The comparison and the identifier can be stored in any suitable format (e.g., a decimal value reflecting the normalization of the actual color ratio to the expected color ratio and an integer associated with the selected benchmark spectral sensitivity). The comparison and the identifier can be written as data stored in the memory of the camera module under test (see, e.g., memory 130 shown in FIG. 1).

Any suitable circuitry can be used for storing the identifier and the comparison at block 670. For example, control circuitry 350 shown in FIG. 3 can store the identifier and the comparison in the memory of the camera module under test (e.g., using the receptacle 310 to electrically couple with the camera module under test).

While the previous description of process 600 discussed selecting a benchmark standard based on a single color ratio, it is understood that any number of color ratios can be used to select a benchmark standard in accordance with the disclosure. For example, process 600 can be modified such that multiple color ratios (e.g., both a red-to-green ratio and a blue-to-green ratio) for each benchmark standard are determined based on a pair of test and true measurements and then the benchmark standard most similar to the camera module under test across all color ratios can be selected. In embodiments using a red-to-green color ratio and a blue-to-green color ratio, the most similar benchmark standard may be selected by finding the benchmark standard that will minimize the following expression:

$${( \frac{R}{G} Actual - \frac{R}{G} Benchmark )}^{2} + {( \frac{B}{G} Actual - \frac{B}{G} Benchmark )}^{2}$$

In accordance with the disclosure, systems and methods for camera measurement synchronization are provided. As previously discussed, a spectrometer can continually or periodically capture measurements. However, it can be challenging to accurately identify a spectrometer measurement (e.g., a true measurement) that is contemporaneous with a test measurement from a camera module. To address this problem, synchronization between a camera module's test measurement and a spectrometer can be achieved using a flash unit. For example, a flash unit integrated into a camera module or a flash unit electrically coupled with a camera module (see, e.g., flash unit 215 shown in FIG. 2) can provide highly-accurate timing markers in the spectrometer measurements and these markers can be used to identify contemporaneous measurements.

FIG. 7 is a flow chart of an illustrative process 700 for camera measurement synchronization in accordance with some embodiments of the invention. Process 700 can be used to synchronize measurements including those from any suitable type of camera module (see, e.g., camera module 100 shown in FIG.1 and camera module 214 shown in FIG. 2). Synchronization process 700 can be performed by test station 300 shown in FIG. 3. Process 700 can begin with blocks 710 and 720 occurring generally in parallel.

At block 710, a continuous stream of optical measurements can be captured with an optical sensor. For example, a continuous stream of optical measurements can be captured using spectrometer 340 shown in FIG. 3. It is understood that the continuous stream of optical measurements can include a temporal resolution based on hardware or software limitations, and therefore may not include a measurement for every single unit of time (e.g., every millisecond) even though it is considered a continuous stream.

At block 720, a flash can be triggered. The flash can be triggered by a camera module. For example, a flash unit integrated into a camera module can be triggered. As another example, a flash unit electrically coupled with a camera module can be triggered by the camera module (see, e.g., flash unit 215 shown in FIG. 2). In some embodiments, the camera module may also be triggered to take an instantaneous camera measurement (e.g., capturing a still image) at the same time that the flash is triggered. For example, test station 300 shown in FIG. 3 can trigger a camera module under test to take an instantaneous camera measurement, which will also trigger a flash.

At block 730, an instantaneous camera measurement can be captured with a camera module. For example, a camera module can capture a still image. In some embodiments, the instantaneous measurement may be captured after a predetermined amount of time has passed since the flash. As will be discussed with respect to block 750, this predetermined amount of time can be important for synchronization purposes. In some embodiments, block 730 can include capturing an instantaneous camera measurement at a time when there is no flash. For example, it may be desirable to obtain camera measurements or optical measurements that are not affected by a flash, and this can be done by waiting a predetermined amount of time after block 720 before the instantaneous camera measurement is captured at block 730.

At block 740, the flash in the continuous stream of optical measurements can be identified. The flash will show up as a pulse of light in the continuous stream of optical measurements and this can be easily identified.

Any suitable circuitry can be used to identify the flash at block 740. For example, control circuitry 350 shown in FIG. 3 can analyze the continuous stream of optical measurements (e.g., received from spectrometer 340) and identify the flash.

At block 750, an instantaneous optical measurement that is contemporaneous with the instantaneous camera measurement can be identified from the continuous stream of optical measurements based on the time of the flash in the continuous stream of optical measurements. For example, if the instantaneous camera measurement was not captured until a predetermined amount of time passed after the flash, that amount of time will also dictate the delay between the time of the flash in the continuous stream of optical measurements and the optical measurement that is contemporaneous with the instantaneous camera measurement.

Any suitable circuitry can be used to identify the instantaneous optical measurement that is contemporaneous with the instantaneous camera measurement at block 750. For example, control circuitry 350 shown in FIG. 3 can analyze the continuous stream of optical measurements (e.g., received from spectrometer 340) and identify the instantaneous optical measurement that is contemporaneous with the instantaneous camera measurement.

In some embodiments, camera measurement synchronization can include triggering multiple flashes. For example, additional flashes could be triggered before or after the instantaneous camera measurement is captured. Triggering multiple flashes can be beneficial because it can create additional marks in the continuous stream of optical measurements with which to locate the optical measurement contemporaneous with the camera measurement. For example, a first flash can be triggered a predetermined amount of time before the camera measurement and then a second flash can be triggered the same predetermined amount of time after the camera measurement. In such an example, the optical measurement that is contemporaneous with the camera measurement would be located equidistant between the two flashes in the continuous stream of optical measurements. Such embodiments may be beneficial because they may avoid problems related to synchronization between the camera module under test and the spectrometer.

FIG. 8 is a flow chart of an illustrative process 800 for camera measurement synchronization in accordance with some embodiments of the invention. Process 800 can be used to synchronize measurements including those from any suitable type of camera module (see, e.g., camera module 100 shown in FIG.1 and camera module 214 shown in FIG. 2). Synchronization process 800 can be performed by test station 300 shown in FIG. 3. Process 800 can begin with blocks 810 and 820 occurring generally in parallel. Blocks 810, 820 and 830 of process 800 are substantially similar to blocks 710, 720 and 730 of process 700, and the previous description of the latter can be applied to the former.

At block 840, a second flash can be triggered. Similar to the first flash, the second flash can be triggered by a camera module. For example, a flash unit integrated into a camera module can be triggered. As another example, a flash unit electrically coupled with a camera module can be triggered by the camera module (see, e.g., flash unit 215 shown in FIG. 2). In some embodiments, the camera module may also be triggered to take an instantaneous camera measurement (e.g., capturing a still image) at the same time that the flash is triggered. For example, test station 300 shown in FIG. 3 can trigger a camera module under test to take an instantaneous camera measurement, which will also trigger a flash.

In some embodiments, the second flash in block 840 may be triggered after a predetermined amount of time has passed since the instantaneous camera measurement was captured in block 830. This predetermined amount of time can be important for synchronization purposes. For example, the predetermined amount of time used to determine when to trigger the second flash at block 840 may be the same as the predetermined amount of time used to determine when to capture the instantaneous camera measurement at block 830 after the first flash. Accordingly, the instantaneous camera measurement may have occurred at the halfway point between the first flash and the second flash.

At block 850, the first and second flashes in the continuous stream of optical measurements can be identified. Each flash will show up as a pulse of light in the continuous stream of optical measurements and this can be easily identified.

Any suitable circuitry can be used to identify the first and second flashes at block 850. For example, control circuitry 350 shown in FIG. 3 can analyze the continuous stream of optical measurements (e.g., received from spectrometer 340) and identify the flashes.

At block 860, an instantaneous optical measurement that is contemporaneous with the instantaneous camera measurement can be identified from the continuous stream of optical measurements based on the times of the first and second flashes in the continuous stream of optical measurements. For example, if the instantaneous camera measurement was captured after a predetermined amount of time passed after the first flash and then the second flash occurred a predetermined amount of time after the instantaneous camera measurement, the two predetermined time delays can be used to determine the measurement in the continuous stream of optical measurements that is contemporaneous with the instantaneous camera measurement. For example, if the predetermined amounts of time are equal and the instantaneous camera measurement occurred at the halfway point between the first and second flashes, the measurement in the continuous stream of optical measurements that is exactly in between the first and second flashes may be contemporaneous with the instantaneous camera measurement.

Any suitable circuitry can be used to identify the instantaneous optical measurement that is contemporaneous with the instantaneous camera measurement at block 860. For example, control circuitry 350 shown in FIG. 3 can analyze the continuous stream of optical measurements (e.g., received from spectrometer 340) and identify the instantaneous optical measurement that is contemporaneous with the instantaneous camera measurement.

Therefore, those skilled in the art will appreciate that the invention can be practiced by other than the described embodiments, which are presented for purposes of illustration rather than of limitation.

It is to be understood that the steps shown in process 400 of FIG. 4, process 500 of FIG. 5, process 600 of FIG. 6, process 700 of FIG. 7 and process 800 of FIG. 8 are merely illustrative and that existing steps may be modified or omitted, additional steps may be added, and the order of certain steps may be altered.

Moreover, the processes described with respect to FIGS. 4-8, as well as any other aspects of the invention, may each be implemented by software, but may also be implemented in hardware, firmware, or any combination of software, hardware, and firmware. They each may also be embodied as machine- or computer-readable code recorded on a machine- or computer-readable medium. The computer-readable medium may be any data storage device that can store data or instructions which can thereafter be read by a computer system. Examples of the computer-readable medium may include, but are not limited to, read-only memory, random-access memory, flash memory, CD-ROMs, DVDs, magnetic tape, and optical data storage devices (e.g., memory 352 of FIG. 3). The computer-readable medium can also be distributed over network-coupled computer systems so that the computer readable code is stored and executed in a distributed fashion. For example, the computer-readable medium may be communicated from one test station to another test station using any suitable communications protocol (e.g., the computer-readable medium may be communicated to test station 300 via control circuitry 350). The computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

What is claimed is:

1. A camera test station comprising:
a spectrometer configured to receive light from a surface;
a receptacle configured to receive a camera module under test so that the camera module under test receives light from the surface; and
control circuitry electrically coupled with the spectrometer and configured to:
electrically couple with the camera module under test;
trigger the camera module under test to capture a test measurement; and
contemporaneously receive a true measurement from the spectrometer.

2. The camera test station of claim 1, further comprising:
a flash unit configured to electrically couple with the camera module under test.

3. The camera test station of claim 1, further comprising:
a target on the surface, wherein the test measurement is an image of the target.

4. The camera test station of claim 1, further comprising:
a target on the surface;
a first light source configured to illuminate the target with a first type of light;
a second light source configured to illuminate the target with a second type of light; and
the first type of light is different from the second type of light.

5. The camera test station of claim 1, wherein the control circuitry is further configured to:
determine an actual color ratio based on the test measurement;
combine the true measurement with a benchmark spectral sensitivity to determine an expected color ratio; and
compare the actual color ratio to the expected color ratio to generate calibration data.

6. The camera test station of claim 5, wherein the benchmark spectral sensitivity represents the spectral sensitivity of a benchmark camera module.

7. The camera test station of claim 5, wherein the control circuitry is further configured to store the calibration data in memory within the camera module under test.

8. A camera module comprising:
an image sensor configured to capture images; and
memory coupled to the image sensor and configured to store calibration data that is based on a comparison between:
an actual color ratio based on a test measurement captured by the image sensor; and
an expected color ratio generated by combining a true measurement with a benchmark spectral sensitivity.

9. The camera module of claim 8, wherein the benchmark spectral sensitivity represents the spectral sensitivity of a benchmark camera module.

10. The camera module of claim 8, wherein the calibration data represents a comparison of the camera module to a benchmark camera module.

11. A camera test station comprising:
a target;
a first light source configured to illuminate the target;
a spectrometer configured to receive light from the target;
a receptacle configured to receive a camera module under test; and
control circuitry electrically coupled with the spectrometer and configured to:
electrically couple with the camera module under test;
trigger the camera module under test to capture a test measurement; and
receive a true measurement from the spectrometer.

12. The camera test station of claim 11, wherein the test measurement and the true measurement are contemporaneous.

13. The camera test station of claim 11, wherein the test measurement is an image of the target.

14. The camera test station of claim 11, wherein the control circuitry is further configured to:
determine an actual color ratio based on the test measurement;
combine the true measurement with a benchmark spectral sensitivity to determine an expected color ratio; and
compare the actual color ratio to the expected color ratio to generate calibration data.

15. The camera test station of claim 14, wherein the benchmark spectral sensitivity represents the spectral sensitivity of a benchmark camera module.

16. The camera test station of claim 14, wherein the control circuitry is further configured to store the calibration data in memory within the camera module under test.

17. A camera test and calibration method comprising:
capturing a test measurement with a camera module under test;
contemporaneously capturing a true measurement with a spectrometer;
combining the true measurement with a benchmark spectral sensitivity to determine an expected color ratio;
determining an actual color ratio based on the test measurement;
comparing the actual color ratio to the expected color ratio; and
storing the comparison in memory within the camera module under test.

18. The method of claim 17, further comprising:
providing illumination during the capturing the test measurement and the contemporaneously capturing the true measurement.

19. The method of claim 17, wherein the test measurement is an image of a target.

20. The method of claim 17, wherein the benchmark spectral sensitivity represents the spectral sensitivity of a benchmark camera module.

21. The method of claim 17, further comprising:
combining the true measurement with the benchmark spectral sensitivity to determine a second expected color ratio;
determining a second actual color ratio based on the test measurement;
comparing the second actual color ratio to the second expected color ratio to generate a second comparison; and
storing the second comparison in memory within the camera module under test.

22. The method of claim 17, further comprising:
triggering a flash;
identifying the flash in spectrometer measurements; and
identifying, from the spectrometer measurements, the true measurement based on the time of the flash in the spectrometer measurements, wherein the flash and the true measurement are separated by a predetermined amount of time.

23. The method of claim 17, further comprising:
triggering a first flash;
triggering a second flash;
identifying the first flash and the second flash in spectrometer measurements; and
identifying, from the spectrometer measurements, the true measurement based on the time of the first flash and the second flash in the spectrometer measurements, wherein:
the first flash and the true measurement are separated by a first predetermined amount of time; and
the second flash and the true measurement are separated by a second predetermined amount of time.

24. The method of claim 23, wherein:
the triggering the second flash is after the capturing the test measurement; and
the first predetermined amount of time is equal to the second predetermined amount of time.

25. A camera test and calibration method comprising:
capturing a test measurement with a camera module under test;
contemporaneously capturing a true measurement with a spectrometer;
combining the true measurement with a set of benchmark spectral sensitivities to determine a set of expected color ratios;
determining an actual color ratio based on the test measurement;
comparing the actual color ratio to each of the expected color ratios in the set of expected color ratios;
selecting an expected color ratio from the set that is most similar to the actual color ratio; and
storing in memory within the camera module under test:
an identifier of the benchmark spectral sensitivity used to determine the selected color ratio; and
the comparison between the actual color ratio and the selected color ratio.

26. The method of claim 25, wherein each benchmark spectral sensitivity in the set of benchmark spectral sensitivities represents the spectral sensitivity of a respective benchmark camera module.

27. A camera measurement synchronization method comprising:
capturing a continuous stream of optical measurements with an optical sensor;
triggering a first flash;
capturing an instantaneous camera measurement with a camera;
identifying the first flash in the continuous stream of optical measurements; and
identifying, from the continuous stream of optical measurements, an instantaneous optical measurement that is contemporaneous with the instantaneous camera measurement based on the time of the first flash in the continuous stream of optical measurements.

28. The method of claim 27, further comprising:
triggering a second flash; and
identifying the second flash in the continuous stream of optical measurements, wherein the identifying the instantaneous optical measurement that is contemporaneous with the instantaneous camera measurement is further based on the time of the second flash.

29. The method of claim 27, further comprising:
generating calibration data based on the instantaneous optical measurement and the instantaneous camera measurement.

30. The method of claim 28, further comprising:
storing the calibration data in the camera.
